(19) United States
(12) Patent Application Publication
(10) Pub. No.: US 2014/0269633 A1
(43) Pub. Date: Sep. 18, 2014

(54) COEXISTENCE OF A WIRELESS WIDE AREA NETWORK DEVICE IN TIME DIVISION DUPLEX (TDD) MODE WITH A WIRELESS ACCESS POINT (AP)

(71) Applicant: Qualcomm Incorporated, San Diego, CA (US)

(72) Inventors: Firouz Behnamfar, San Jose, CA (US); Alireza Raissinia, Monte Sereno, CA (US); Sandip Homchaudhuri, San Jose, CA (US)

(73) Assignee: Qualcomm Incorporated, San Diego, CA (US)

(21) Appl. No.: 14/059,484

(22) Filed: Oct. 22, 2013

Related U.S. Application Data
(60) Provisional application No. 61/785,466, filed on Mar. 14, 2013.

(51) Int. Cl. H04L 5/00

(52) U.S. Cl. CPC H04L 5/0073; H04L 5/0085
USPC 370/336

(57) ABSTRACT

In one embodiment, a wireless access point (AP) receives messages from a wireless wide area network (WWAN) device, wherein these messages identify parameters of future WWAN frames. Each message identifies a starting time, an operating band, an upload/download sub-frame configuration, and a special sub-frame pattern of a WWAN frame. The AP uses the parameters defined by each received message to determine whether to transmit a beacon frame at a scheduled target beacon transmission time (TBTT), or delay the transmission of the beacon frame to a delayed TBTT. The AP will not delay the scheduled TBTT if the parameters defined by the received message indicate there are no co-existence problems. However, the AP will delay a transmission from the scheduled TBTT if this scheduled TBTT coincides with a downlink sub-frame of the WWAN frame, and the WWAN frame has an operating band subject to interference from the intended transmission.

### CROSS REFERENCES

The present application for patent claims priority benefit of co-pending U.S. Provisional Patent Application No. 61/785,466, entitled “Coexistence of LTE Device in Time Division Duplex (TDD) Mode With WLAN Access Point (AP)” by Behnamfar et al., filed Mar. 14, 2013, assigned to the assignee hereof, and expressly incorporated by reference herein.

### FIELD OF THE DISCLOSURE

The present disclosure relates to a wireless communication system that includes both wireless local area network (WLAN) devices and wireless wide area network (WWAN, e.g., long term evolution (LTE)) devices.

### RELATED ART

When WLAN and WWAN devices are collocated and use close channels, these devices must coordinate their activities to minimize interference between the devices. Techniques used to minimize interference in the manner are referred to as ‘co-existence’ methods. In particular, it is desirable to implement co-existence methods to prevent WLAN device transmissions from causing interference with LTE communications (e.g., downlink (DL) receptions, uplink (UL) transmissions). A WLAN access point (AP) must periodically transmit beacon frames (e.g., every 100 msec) in order to maintain a basic service set (BSS). Co-existence methods are complicated by this beacon frame requirement. These co-existence methods become more complex in a communication system that implements a WLAN AP that supports multiple basic service sets (BSSs), and therefore must periodically transmit multiple sets of beacon frames.

It would therefore be desirable to have a method and structure for allowing WLAN APs to periodically transmit beacon signals for one or more associated BSSs, wherein the transmitted beacon signals do not interfere with LTE communications.

### SUMMARY

Accordingly, the present disclosure provides a wireless communication system including both a WLAN AP and a WWAN device, wherein co-existence problems may exist between these devices. The WWAN device transmits messages to the WLAN AP, wherein the messages include information identifying parameters of WWAN frames to be transmitted/received by the WWAN device. In one embodiment, the WWAN is LTE (but may be any similar WWAN technology), wherein each message identifies a starting time of the future LTE frame, an operating band of the LTE frame, an upload/download sub-frame configuration of the LTE frame, and a special sub-frame pattern of the LTE frame.

The WLAN AP may determine a transmission time of the LTE frame in response to the received message, and in response, determine whether the transmission time of the LTE frame coincides with a scheduled transmission time (e.g., target beacon transmission time (TBTT), scheduled data transmission time). If not, the WLAN AP may transmit a beacon (or data) at the scheduled transmission time.

The WLAN AP may determine the operating band of the LTE frame from the received message, and in response, determine whether the operating band is subject to interference from the transmission (e.g., transmission of the beacon, transmission of the data). If not, the WLAN AP may transmit the beacon at the scheduled transmission time.

The WLAN AP may determine the uplink/downlink sub-frame configuration of the LTE frame from the received message, and in response, determine whether the transmission time coincides with an uplink sub-frame, a downlink sub-frame, or a special sub-frame of the LTE frame.

If the scheduled transmission time coincides with an uplink sub-frame of the LTE frame, the WLAN AP may transmit at the scheduled transmission time, assuming that the transmission duration is less than the duration of the uplink sub-frame, and any consecutive uplink sub-frames. If the transmission duration is too long to be transmitted during the duration of the uplink sub-frame (and any consecutive up-link sub-frames), then the WLAN AP delays the scheduled transmission time to a time that avoids co-existence problems.

If the scheduled transmission time coincides with a special sub-frame, the WLAN AP may transmit at the scheduled transmission time, as long as the scheduled TBTT coincides with a guard period or a downlink pilot time slot of the special sub-frame, and the beacon duration is less than a time period extending from the scheduled transmission time to the end of a following uplink sub-frame (or the end of a plurality of consecutive following uplink sub-frames). If the transmission duration is too long to be transmitted during this time period, then the WLAN AP delays the scheduled transmission time to a time that avoids co-existence problems.

If the scheduled transmission time coincides with a downlink sub-frame of the LTE frame, then the WLAN AP delays the scheduled transmission time to a time that avoids co-existence problems.

In one embodiment, the WLAN AP delays the scheduled transmission time to a time that avoids co-existence problems by delaying the transmission time until the next scheduled special sub-frame of the LTE frame. In one embodiment, the transmission time is rescheduled to a guard period of the next scheduled special sub-frame of the LTE frame. In another embodiment, the transmission time is rescheduled to a downlink pilot time slot of the next scheduled special sub-frame of the LTE frame. By rescheduling the transmission time in this manner, the WLAN AP does not transmit during communications (e.g., data transmissions, data receptions, for example downlink sub-frames) of the LTE device, thereby avoiding co-existence problems.

### BRIEF DESCRIPTION OF THE DRAWINGS

FIG. 1 is a block diagram of a wireless communication system that includes a WLAN AP and an LTE device in accordance with one embodiment.

FIG. 2 is a table illustrating the uplink and downlink operating bands for various operating bands used to transmit time division duplex (TDD) frame structures in an LTE system.

FIG. 3 is a block diagram illustrating the various fields of a message transmitted from the LTE device of FIG. 1 to the WLAN AP of FIG. 1 in accordance with one embodiment.

FIG. 4 is a table illustrating seven possible uplink/downlink sub-frame configurations defined by the message of FIG. 3 in accordance with one embodiment.

FIG. 5 is a block diagram illustrating the format of a special sub-frame of an LTE frame, in accordance with one embodiment.

FIG. 6 is a table illustrating nine possible special sub-frame configurations defined by the message of FIG. 3 in accordance with one embodiment.

FIG. 7A is a flow diagram illustrating the manner in which the WLAN AP of FIG. 1 transmits beacon frames in response to messages provided by the LTE device of FIG. 1, in accordance with one embodiment.

FIG. 7B is a flow diagram illustrating the manner in which the WLAN AP of FIG. 1 delays transmitting until a time designated for the next LTE special sub-frame, in accordance with one embodiment.

FIG. 8 is a block diagram illustrating the manner in which a frame is transmitted during a time designated for an LTE special sub-frame in accordance with one embodiment.

FIG. 9 is a block diagram illustrating the timing of beacons for multiple basic service sets (BSSs), along with the timing of multiple corresponding LTE frames, in accordance with one embodiment.

FIG. 10 is a block diagram illustrating a method allowing the WLAN AP of FIG. 1 to transmit to corresponding WLAN stations during time periods specified for LTE downlink sub-frames in accordance with one embodiment.

### DETAILED DESCRIPTION

FIG. 1 is a block diagram of a wireless communication system 100. Wireless communication system 100 includes WLAN access point (AP) 110, which may be coupled to the Internet 105 in a manner known to those of ordinary skill in the art. WLAN AP 110 implements a first basic service set (BSS) 101 that includes WLAN stations (STAs) 111-112, and also implements a second BSS 102 that includes WLAN STAs 113-114. Although embodiments of the present disclosure are described in connection with two BSSs 101 and 102 having two WLAN STAs each, it is understood that other numbers of BSSs and/or WLAN STAs may be implemented in other embodiments of the present disclosure. Wireless communication system 100 also includes an LTE device 120, which engages in wireless communication with LTE base station 125.

In some embodiments of the present disclosure, WLAN AP 110 may be a standalone AP, or the AP 110 may be integrated into another device, such as, but not limited to, a femtocell, picocell, mobile device (e.g., mobile phone or WAN enabled tabled or computer, etc.). In some of those embodiments, WLAN AP 110 operates in accordance with an IEEE 802.11 protocol. Thus, WLAN AP 110 must periodically transmit a first set of beacon frames to WLAN STAs 111-112 at a first set of specific times (e.g., target beacon transmission times (TBTTs)) in order to maintain BSS 101. Similarly, WLAN AP 110 may periodically transmit a second set of beacon frames to WLAN STAs 113-114 at a second set of specific times (e.g., target beacon transmission times (TBTTs)) in order to maintain BSS 102. In one embodiment, the IEEE 802.11 protocol specifies that the beacon frames for a BSS should be transmitted every 100 msec. However, this protocol can tolerate beacon frames that are slightly delayed from the scheduled TBTTs.

In one example, the IEEE 802.11b/g/n protocols provide for wireless communications using 14 channels in a frequency band of 2.4 to 2.5 GHz (hereinafter referred to as the 2.4 GHz band). In the described embodiments, WLAN AP 110 communicates with WLAN STAs 111-114 using the 2.4 GHz band. In order for WLAN AP 110 and LTE device 120 to co-exist within communication system 100, the beacon (and data) transmissions of WLAN AP 110 should not interfere with LTE device 120 communications (receiving data from the LTE base station 125, for example). Thus, in accordance with some embodiments of the present disclosure, WLAN AP 110 does not transmit beacon (or data) frames while LTE device 120 is receiving data from LTE base station 125.

LTE device 120 communicates with LTE base station 125 over an E-UTRA band 122. LTE device 120 can communicate using a frequency division duplex (FDD) frame structure, or a time division duplex (TDD) frame structure. In some embodiments, the operating bands used to transmit FDD frame structures from LTE base station 125 to LTE device 120 may not be close enough to the 2.4 GHz band to result in co-existence problems (i.e., beacon/data frames transmitted by WLAN AP 110 in the 2.4 GHz band may not interfere with the ability of LTE device 120 to receive FDD frame structures from LTE base station 125). However, some of the operating bands used to transmit TDD frame structures from LTE base station 125 to LTE device 120 may result in co-existence problems in the manner described below.

FIG. 2 is a table 200 illustrating the uplink and downlink operating bands for various LTE operating bands used to transmit TDD frame structures. As illustrated by FIG. 2, E-UTRA operating band ‘40’ implements a downlink operating band of 2.300-2.400 GHz, and E-UTRA operating band ‘41’ implements a downlink operating band of 2.492 to 2.690 GHz. When WLAN AP 110 is operating in the 2.4 GHz band and LTE device 120 is operating in E-UTRA band ‘40’ or band ‘41’, it is possible that beacon/data transmissions by the WLAN AP 110 will interfere with downlink operations of LTE device 120, because the frequencies at the edges of the 2.4 GHz are very close to (or overlapping) the downlink frequencies of E-UTRA bands ‘40’ and ‘41’. Note that external coexistence filters and antenna isolation techniques are not sufficient to solve these co-existence problems.

In accordance with some embodiments of the present disclosure, co-existence of WLAN AP 110 and LTE device 120 is enabled by delaying scheduled transmissions (e.g., beacon transmissions) by WLAN AP 110 to avoid de-sensing downlink operations of LTE device 120. For example, WLAN AP 110 determines when LTE device 120 will be receiving data on E-UTRA bands ‘40’ or ‘41’, and will avoid transmitting beacon frames during these times (e.g., by delaying transmission of the beacon signals). In one variation, WLAN AP 110 may also reduce transmission power, when useful, to avoid interference with reception of LTE device 120.

In accordance with one embodiment, LTE device 120 includes message control logic 121 (which can be implemented by software and/or firmware) that transmits messages 150 to WLAN AP 110, indicating when LTE device 120 is about to receive data from LTE base station 125 (Rx indication), and indicating when LTE device 120 is about to transmit data to LTE base station 125 (Tx indication). An Rx indication message may be transmitted between 0.2 to 1.0 msec before data is to be received by the LTE device 110, and a Tx indication message may be transmitted between 0.2 to 1.0 msec before data is to be transmitted by the LTE device 110. In some embodiments, WWAN communications may include transmitting data during uplink or downlink (e.g., depending on the mode of the WWAN communication system) and/or receiving data during uplink or downlink (e.g., depending on the mode of the WWAN communication system).

FIG. 3 is a block diagram illustrating the various fields of a message 150 transmitted from LTE device 120 to WLAN AP 110 in accordance with one embodiment. As illustrated by FIG. 3, message 150 includes transmit/receive field 301, duplex mode/operating band field 302, uplink/downlink (UL/DL) frame configuration field 303, special sub-frame pattern field 304, and interference information field 305. Interference information field 305 includes a value that identifies a signal to interference plus noise ratio (SINR).

Transmit/receive field 301 includes a value that has a first state to indicate that the message 150 is a Tx indication message, and a second state to indicate the message 150 is an Rx indication message. Transmit/receive field 301 also includes a value that indicates a time when the transmit/receive operation will begin.

Duplex mode/operating band field 302 includes a first value that indicates whether LTE device 120 communicates with LTE base station 125 using an FDD or TDD frame structure, and a second value that identifies the E-UTRA band to be used by LTE device 120 to communicate with LTE base station 125.

Uplink/downlink frame configuration field 303 includes a value that identifies one of seven possible uplink/downlink frame configurations (0-6) implemented by LTE device 120 to communicate with LTE base station 125. FIG. 4 is a table 400 illustrating the seven possible uplink/downlink frame configurations 0-6. Each uplink/downlink frame configuration 0-6 specifies each of ten sub-frames of the LTE frame as either a downlink sub-frame (D), a special sub-frame (S), or an uplink sub-frame (U). For example, an uplink/downlink frame configuration of ‘2’ specifies an LTE frame having, in order, a downlink sub-frame, a special sub-frame, an uplink sub-frame, three downlink sub-frames, a special sub-frame, an uplink sub-frame and two downlink sub-frames. Note that a special sub-frame (described below) is required between each downlink sub-frame to uplink sub-frame transition. In general, LTE device 120 is capable of receiving downlink data from LTE base station 125 during each of the downlink sub-frames (and during a beginning of the special sub-frames), and is capable of transmitting uplink data to the LTE base station 125 during each of the uplink sub-frames (and during an end of the special sub-frames). Each LTE sub-frame has a duration of 1 msec, such that each LTE frame has a duration of 10 msec. As described in more detail below, if WLAN AP 110 is required to transmit a beacon frame during a time when LTE device 120 is communicating with LTE base station 125, then WLAN AP 110 will transmit the beacon frame while LTE device 120 is idle (during certain portions of a special sub-frame of the LTE frame) and/or while LTE device 120 is transmitting (during an uplink sub-frame of the LTE frame, or during uplink portions of a special sub-frame of the LTE frame). Note that uplink/downlink frame configurations ‘2’ and ‘5’ of table 400 provide worst case conditions, as these configurations do not include two consecutive uplink sub-frames.

Returning now to FIG. 3, special sub-frame pattern field 304 includes a value that identifies one of eight possible configurations for the special sub-frames of the LTE frame. FIG. 5 is a block diagram of a special sub-frame 500 of an LTE frame, which includes OFDM symbols 510, downlink pilot time slot (DwPTS) 501, guard period (GP) 502 and uplink pilot time slot (UpPTS) 503. OFDM symbols 510 provide control information associated with the special sub-frame 500. In general, downlink activity may occur during the downlink pilot time slot 501, uplink activity may occur during the uplink pilot time slot 503, and neither downlink nor uplink activity may occur during the guard period 502. As a result, WLAN AP 110 may transmit a beacon during the guard period 502 and uplink pilot time slot 503, without interfering with downlink activity of LTE device 120.

FIG. 6 is a table 600 illustrating the nine possible configurations of special sub-frame 500, with respect to the combined durations of the guard period 502 and uplink pilot time slot 503. For example, a sub-frame having special sub-frame configuration ‘1’ (with a normal cyclic prefix in the downlink) will include a guard period 502 and an uplink pilot time slot 503 having a combined duration of 0.357 msec. As a result, WLAN AP 110 may transmit a beacon signal during the last 0.357 msec of a special sub-frame having special sub-frame configuration ‘1’ (with a normal cyclic prefix in the downlink). Note that special sub-frame configuration ‘4’ of table 600 (with normal cyclic prefix in the downlink) provides a worst case condition, wherein the combined duration of the guard period 502 and the uplink pilot time slot 503 is only 0.143 msec. Similarly, special sub-frame configuration ‘3’ of table 600 (with an extended cyclic prefix in the downlink) provides a worst case condition, wherein the combined duration of the guard period 502 and the uplink pilot time slot 503 is only 0.167 msec.

FIG. 7A is a flow diagram 700 illustrating the manner in which WLAN AP 110 operates to transmit beacon frames in response to messages 150 provided by LTE device 120, in accordance with one embodiment.

Message control logic 121 of LTE device 120 generates messages 150 in response to known communication characteristics of LTE device 120, in the manner described above. LTE device 120 transmits these messages 150 to WLAN AP 110. Message processing logic 115 (which may be implemented with software and/or firmware) within WLAN AP 110 receives these messages 150, and in response, controls beacon/data transmission circuitry 116 of WLAN AP 110 in the following manner.

Message processing logic 115 monitors the received messages 150 to determine whether the target beacon transmission time (TBTT) of WLAN AP 110 coincides with the transmission/receipt of an LTE frame (701). Message processing logic 115 may make this determination in response to the absence of a message 150, or by determining that the transmit/receive time indicated by the Tx/Rx field 301 of the message 150 does not coincide with the TBTT of WLAN 110. If message processing logic 115 determines that the TBTT does not coincide with the transmission/received of an LTE frame (701, No branch), then message processing logic 115 instructs beacon/data transmit circuitry 116 to transmit a beacon frame at the scheduled TBTT (702).

If message processing logic 115 determines that the TBTT coincides with the transmission/receipt of an LTE frame (701, Yes branch), then message processing logic 115 decodes the duplex mode/operating band field 302 of the received message 150 to determine whether the associated LTE frame is being transmitted in TDD mode in E-UTRA operating band ‘40’ or ‘41’ (703). If message processing logic 115 determines that the LTE frame is not being transmitted in E-UTRA operating band ‘40’ or ‘41’ (703, No branch), then no co-existence problem exists, and message processing logic 115 instructs beacon/data transmit circuitry 116 to transmit a beacon frame at the scheduled TBTT (702).

If message processing logic 115 determines that the LTE frame is being transmitted in E-UTRA operating band ‘40’ or ‘41’ (703, Yes branch), then message processing logic 115 decodes the UL/DL configuration field 303 of the received message 150 to determine whether the TBTT coincides with an uplink sub-frame, special sub-frame or downlink sub-frame of the LTE frame (704).

If message processing logic 115 determines that the scheduled TBTT of the beacon corresponds with an uplink sub-frame of the LTE frame (704, UL branch), then message processing logic 115 determines whether the beacon frame may be successfully transmitted during the time period that exists from the scheduled TBTT to the end of the uplink sub-frame (or the end of any additional uplink sub-frames continuous with the uplink sub-frame) (705). In making this determination, message processing logic 115 uses the duration of the beacon frame, which is known within WLAN AP 110.

If message processing logic 115 determines that the beacon frame may be successfully transmitted during the uplink sub-frame(s) (705, Yes branch), then message processing logic 115 instructs beacon/data transmit circuitry 116 to transmit the beacon frame at the scheduled TBTT (702). If message processing logic 115 determines that the beacon frame may not be successfully transmitted during the uplink sub-frame(s) (705, No branch), then message processing logic 115 proceeds to TBTT delay processing 707, which is described in more detail below.

If message processing logic 115 determines that the scheduled TBTT of the beacon corresponds with a special sub-frame of the LTE frame (704, SP branch), then message processing logic 115 determines whether the beacon frame may be successfully transmitted during the time period that exists from the scheduled TBTT through the end of the special sub-frame and continuing through the end of the following uplink sub-frame(s) (706). In making this determination, message processing logic 115 uses the duration of the beacon frame, which is known within WLAN AP 110. In making this determination, message processing logic 115 also decodes the special sub-frame pattern field 304 of message 150 to determine whether the TBTT occurs during the guard period 502 or uplink pilot time slot 503. If not, message processing logic determines that the beacon frame cannot be transmitted at the scheduled TBTT, and processing proceeds to TBTT delay processing 707. If message processing logic 115 determines that the beacon frame may be successfully transmitted during the special sub-frame and following uplink sub-frame(s) (706, Yes branch), then message processing logic 115 instructs beacon/data transmit circuitry 116 to transmit the beacon frame at the scheduled TBTT (702).

If message processing logic 115 determines that the scheduled TBTT of the beacon corresponds with a downlink sub-frame of LTE device 120 (704, DL branch), processing proceeds to TBTT delay processing 707.

FIG. 7B is a flow diagram illustrating TBTT delay processing 707 in accordance with one embodiment. In general, TBTT delay processing 707 causes WLAN AP 110 to delay transmitting the beacon until the next special sub-frame, which is necessarily followed by one or more uplink sub-frames. Delaying the beacon transmission in this manner allows for a longer period to transmit the beacon. Delaying the beacon transmission in this manner also introduces jitter to the beacon transmissions. However, this jitter can be tolerated by the IEEE 802.11 protocol. Note that the maximum delay in beacon transmission will be 10 msec, which will occur if the scheduled TBTT falls on sub-frame ‘2’ of an LTE frame having UL/DL configuration ‘5’ and a special sub-frame configuration of ‘4’, and the beacon is too long to be transmitted during the time period that exists between the TBTT and the end of sub-frame ‘2’.

Turning now to FIG. 7B, message processing logic 115 determines whether the beacon can be transmitted during a time period that starts at the guard period 502 of the next special sub-frame, and continues through the end of the one or more uplink sub-frames that follow the special sub-frame (710). If so, (710, Yes branch), then message processing logic 115 instructs beacon/data transmit logic 116 to delay the transmission of the beacon from the scheduled TBTT to a delayed TBTT that corresponds with the guard period 502 of the next special sub-frame (711).

In the worst case scenario described above (i.e., UL/DL configuration ‘5’ and a special sub-frame configuration ‘4’), the minimum available time to transmit a beacon in accordance with 710 and 711 will be 1.143 msec. Thus, as long as the beacon frame duration is less than 1.143 msec, the beacon can be transmitted with a delayed TBTT, without interfering with the downlink activity of LTE device 120. 710 and 711 are described in more detail below in connection with FIG. 8.

FIG. 8 is a block diagram that illustrates a portion of an LTE frame 800 that includes downlink sub-frame 801, special sub-frame 802 and uplink sub-frame 803. In this example, LTE frame 800 has a UL/DL configuration ‘5’ and a special sub-frame configuration of ‘4’, wherein sub-frames 801, 802 and 803 represent sub-frame locations ‘0’, ‘1’, and 2, respectively, of the LTE frame 800. Special sub-frame 802 includes downlink pilot time slot 501, gap period 502, uplink pilot time slot 503 and control symbols 510, which have been described above in connection with FIG. 5.

As illustrated by FIG. 8, a time period of 1.143 msec exists between the gap period 502 and the end of following uplink sub-frame 803. In accordance with 710 and 711, the duration of the beacon frame 806 is short enough to allow WLAN AP 110 to transmit a clear to send to self (CTS2S) frame 805 at the start of the gap period 502 (i.e., the delayed TBTT), and then transmit the entire beacon frame 806 by the end of the uplink sub-frame 803. The CTS2S frame 805 sets the NAV timers of STAs 111-114 to the duration of the beacon 806 and ensures that WLAN AP 110 is able to get channel access to transmit the beacon frame (i.e., NAV protection is provided).

Returning now to FIG. 7B, if message processing logic 115 determines that the duration of the beacon is longer than the duration of the guard period and the uplink pilot time slot of the next special sub-frame plus the duration of the one or more uplink sub-frames that follow the special sub-frame (710, No branch), then message processing logic 115 determines whether the beacon can be transmitted during a time period that overlaps the downlink pilot time slot 501 of the next special sub-frame, and continues through the end of the one or more uplink sub-frames that follow the special sub-frame (712). If so (712, Yes branch), then message processing logic 115 instructs beacon/data transmit logic 116 to delay the transmission of the beacon from the scheduled TBTT to a delayed TBTT that corresponds with the start of the downlink pilot time slot 501 of the next special sub-frame (713).

712 and 713 are described in more detail below in connection with FIG. 8. As illustrated by FIG. 8, the duration of the beacon 808 is greater than 1.143 msec, and therefore cannot be transmitted during the period associated with guard period 502, uplink pilot time slot 503 and uplink sub-frame 803. In accordance with 712 and 713, the transmission of the beacon signal 808 is allowed to overlap with the downlink pilot time slot 501. That is, WLAN AP 110 transmits CTS2S frame 807 at the start of the downlink pilot time slot 501 (i.e., the delayed TBTT), followed by the beacon frame 808. Note that transmitting the beacon 808 during the downlink pilot time slot 501 may result in the least amount of damage to the LTE downlink process because the downlink pilot time slot 501 is often unused.

When transmitting the beacon frame 808 during the downlink pilot time slot 501 as illustrated in FIG. 8, the following constraints should be observed. First, the transmission of the beacon signal 808 should never overlap with the first two OFDM symbols 510 of the special sub-frame 802, because these symbols 510 include necessary LTE downlink control information (e.g., UL HARQ ACK/NACK). However, even if the beacon transmission process is started after receiving the first two OFDM symbols 510, the time allowed for transmitting of the beacon signal 808 will still be at least 1.83 msec.

In addition, transmission of a beacon frame should not be allowed to overlap with the downlink pilot time slot in a special sub-frame in sub-frame location ‘6’ (e.g., as included in UL/DL configurations ‘0’, ‘1’, ‘2’ and ‘6’ in FIG. 4). An exception to this rule can be made if the WLAN AP 110 is aware that the special sub-frame at sub-frame location ‘6’ is not an LTE paging occasion. In this embodiment, message 150 must be modified to include paging cycle and occasion information, or the paging cycle and occasion information must be provided to the WLAN AP 110 through a vendor specific message. In another embodiment, LTE device 120 predicts whether it will receive downlink control information in the downlink pilot time slot 501 of special sub-frame 802. If LTE device 120 determines that it will not receive downlink control information, then LTE device 120 transmits a message to WLAN AP 110, thereby informing WLAN AP 110 that it may transmit a beacon signal during downlink pilot time slot 501, if necessary.

Returning now to FIG. 7B, if message processing logic 115 determines that the beacon cannot be transmitted during a period that extends from the downlink pilot time slot 501 through the end of the following uplink sub-frame(s) (712, No branch), then WLAN AP 110 may change its operating channel in the 2.4 GHz band to avoid E-UTRA operating band ‘40’ and/or E-UTRA operating band ‘41’ (714).

The operation of WLAN STAs 111-114 will now be described in more detail. WLAN STAs 111-114 may operate in different manners to receive the delayed beacons in accordance with different embodiments of the present disclosure. In a first embodiment, each WLAN STA wakes up at its scheduled TBTT and stays awake for an extended period to receive the potentially delayed beacon. As described above, under worst case conditions, a beacon will be delayed 10 msec. Thus, in accordance with one embodiment, the WLAN STAs will stay awake for 10.24 msec (e.g., 10 timing units (TUs)) after the scheduled TBTT. The WLAN STA will only consider a beacon to be ‘missed’ if the WLAN STA does not detect a beacon during the 10.24 msec period. A WLAN STA receiving a delayed beacon processes this received beacon in a standard manner (e.g., synchronize the TSF timer, decode the TIM bit and other IEs, etc.)

In another embodiment each of the WLAN STAs 111-114 wakes up at its scheduled TBTT and stays awake for a short interval (e.g., less than 1 msec). If the WLAN STA does not detect a beacon during the short interval, the WLAN STA increments its missed beacon count and re-enters sleep mode until the next few TBTTs pass. The WLAN STA then wakes up at the scheduled TBTT and stays awake for the short interval to detect the beacon. This embodiment assumes that after a few TBTTs elapse, the beacon transmitted by the WLAN AP 110 will fall within the window of reception (i.e., TBTT+<1 msec) of the WLAN STA.

In another embodiment, each of the WLAN STAs 111-114 senses the absence of signal energy at the scheduled TBTT and assumes that the WLAN AP 110 is out of range. In this case, each WLAN STA hunts for a new BSS and may end up re-associating with the WLAN AP 110 (e.g., in the same BSS).

Note that the problem of transmitting beacons in a manner that avoids LTE downlink receptions becomes more severe for each additional BSS supported by WLAN AP 110. When supporting multiple BSSs, a WLAN AP normally transmits beacons in an equally spaced manner over the TBTT interval. In accordance with one embodiment, WLAN AP 110 selects the duration between beacons to be a multiple of the duration of an LTE frame (e.g., 10 msec). FIG. 9 is a block diagram illustrating the timing of beacons for five different BSSs associated with WLAN AP 110 (e.g., BSSID_{—}1, BSSID_{—}2, BSSID_{—}3, BSSID_{—}4 and BSSID_{—}5), along with the timing of twelve corresponding LTE frames 901-112. In FIG. 9, the TBTT of each BSS is set as a multiple of 10 msec, which is the LTE frame duration. WLAN AP 110 introduces a bias between beacons of different BSSs and transmits these beacons in an interleaved manner. In the example of FIG. 9, WLAN AP 110 cycles through the beacons every 20 msec. In accordance with one embodiment, WLAN AP 110 causes the beacons to coincide with desired sub-frames of the LTE frames in view of the known LTE UL/DL configuration 303 and special sub-frame pattern 304.

Note that if UL/DL configuration ‘5’ is implemented, and WLAN AP 110 supports multiple BSSs, there will not be many opportunities for the WLAN AP 110 to transmit beacons (or data frames). In this case, the WLAN AP 110 may change the channel(s) used in the BSSs to avoid the channels in the 2.4 GHz band adjacent to (or overlapping with) E-UTRA channels ‘40’ and ‘41’.

The description above describes the manner in which WLAN AP 110 transmits beacons in view of the operation of LTE device 120. However, the disclosure is not limited to the transmission of beacons. For example, the manner in which WLAN AP 110 transmits data to STAs 111-114 may be controlled in a similar manner. WLAN AP 110 transmits data to WLAN STAs 111-114 in conventional manner if WLAN AP 110 does not receive any messages 150 that indicate downlink reception at the LTE device 120 on E-UTRA channels ‘40’ and ‘41’. However, if WLAN AP 110 receives a message 150 that identifies downlink reception at the LTE device 120 on E-UTRA channels ‘40’ and ‘41’, then WLAN AP 110 identifies the time periods during which downlink sub-frames, special sub-frames and uplink sub-frames will occur in the manner described above. WLAN AP 110 may then transmit data during time periods specified for uplink sub-frames and special sub-frames in the manner described above.

In addition, WLAN AP 110 can transmit data during time periods specified for downlink sub-frames, as long as there is no data destined for LTE device 120 during these downlink sub-frames (as indicated by the transmission of a ‘grant’ message from LTE device 120 to WLAN AP 110). This process is described in more detail below in connection with FIG. 10.

FIG. 10 is a block diagram 1000 illustrating one method allowing WLAN AP 110 to transmit data to WLAN STAs 111-114 during time periods specified for downlink sub-frames for LTE device 120. As illustrated in FIG. 10, LTE device 120 receives the first two OFDM symbols 1002 of downlink sub-frame 1001 of an LTE frame, and in response, determines that downlink sub-frame 1001 does not include downlink data for LTE device 120. Note that for a normal cyclic prefix, the WLAN AP 110 must not transmit during the first 0.143 msec of the downlink sub-frame 1001, and for an extended cyclic prefix, the WLAN AP 110 must not transmit during the first 0.167 msec of the downlink sub-frame 1001, in order to allow the OFDM symbols 1002 to be received (without interference) by LTE device 120. In response to determining that the downlink sub-frame 1001 does not include downlink data, LTE device 120 transmits a grant message 1003 to WLAN AP 110, indicating that WLAN AP 110 may transmit data to its associated WLAN STAs 111-114 during the time period designated for downlink sub-frame 1001. In response, WLAN AP 110 transmits a CTS2S frame 1004, which clears the associated channel for the duration of the downlink sub-frame 1001, and then transmits data 1005 until the end of the downlink sub-frame 1001. In the described embodiments, WLAN AP 110 will typically be able to use about 0.5 msec of the 1 msec downlink sub-frame duration to transmit data 1005.

As illustrated by FIG. 10, the next LTE sub-frame 1011 is also a downlink sub-frame. Consequently, WLAN AP 110 stops transmitting data 1005 by the beginning of this next sub-frame 1011, thereby allowing LTE device 120 to receive the first two OFDM symbols 1012 of this downlink sub-frame 1011. In response, LTE device 120 determines that this downlink sub-frame 1011 does not include downlink data for LTE device 120, and transmits grant message 1013 to WLAN AP 110. In response, WLAN AP 110 transmits CTS2S frame 1014 and data 1015 in the manner illustrated.

Note that if an uplink sub-frame followed the downlink sub-frame 1001, it would not be necessary for WLAN AP 110 to stop sending data at the end of downlink sub-frame 1001 in the manner illustrated by FIG. 10. Instead, the transmit data 1005 could be continued through the following uplink sub-frame.

Note that WLAN AP 110 is allowed (by the IEEE 802.11 protocol) to fragment data transmitted to WLAN STAs 111-114, thereby allowing data to be transmitted during the short transmission opportunities provided by downlink sub-frames that do not include downlink data for LTE device 120 (FIG. 10). In contrast, the beacons transmitted by WLAN AP 110 may not be allowed to be fragmented in the same manner, such that the transmission of beacons and data may be performed in separate manners as described above.

In some embodiments, for WLAN devices operating in accordance with IEEE 802.11b (11 Mbps maximum rate), data fragmentation should be used when transmitting data during downlink sub-frames as illustrated by FIG. 10. For WLAN devices operating in accordance with IEEE 802.11g (54 Mbps maximum rate), data fragmentation should be used when transmitting data (with data rates of 20 Mbps) during downlink sub-frames as illustrated by FIG. 10. For WLAN devices operating in accordance with IEEE 802.11n and or 802.11ac, no more than about 6 to 8 MPDUs (MAC protocol data units) should be allowed in an aggregated MPDU (A-MPDU) when transmitting data during downlink sub-frames as illustrated by FIG. 10.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

We claim:

1. A method comprising:
determining in a first wireless communication system a first period during which at least one device in a second wireless communication system will be communicating in the second wireless communication system; and
delaying a transmission in the first wireless communication system scheduled to be transmitted during the first period until after the first period.

2. The method of claim 1, wherein the delayed transmission comprises a beacon.

3. The method of claim 1, wherein communicating comprises an at least one from the group consisting of:
transmitting data during uplink or downlink depending on a mode of the second wireless communication system; and
receiving data during uplink or downlink depending on the mode of the second wireless communication system.

4. The method of claim 1, wherein the first wireless communication system implements a first wireless communication protocol and the second wireless communication system implements a second wireless communication protocol, the first wireless communication protocol different than the second wireless communication protocol.

5. The method of claim 4, wherein the first wireless communication protocol is an IEEE 802.11 protocol.

6. The method of claim 5, wherein the second wireless communication protocol is a Long Term Evolution (LTE) protocol.

7. The method of claim 1, further comprising receiving in the first wireless communication system a message from the second wireless communication system, wherein determining the first period is in response to receiving the message.

8. The method of claim 7, wherein the message identifies an at least one from the group consisting of:
an operating frequency band in the second wireless communication system;
a pattern of upload sub-frames and download sub-frames included in frames implemented in the second wireless communication system; and
a format of special sub-frames included in frames implemented in the second wireless communication system.

9. A wireless access point comprising:
a processor; and
a memory in electronic communication with the processor, the memory embodying instructions, the instructions being executable by the processor to:
determine in a first wireless communication system a first period during which at least one device in a second wireless communication system will be communicating in the second wireless communication system; and
delay a transmission in the first wireless communication system scheduled to be transmitted during the first period until after the first period.

10. The wireless access point of claim 9, wherein the delayed transmission comprises a beacon.

11. The wireless access point of claim 9, wherein communicating comprises an at least one from the group consisting of:
transmitting data during uplink or downlink depending on a mode of the second wireless communication system; and
receiving data during uplink or downlink depending on the mode of the second wireless communication system.

12. The wireless access point of claim 9, wherein the first wireless communication system implements a first wireless communication protocol and the second wireless communication system implements a second wireless communication protocol, the first wireless communication protocol different than the second wireless communication protocol.

13. The wireless access point of claim 12, wherein the first wireless communication protocol is an IEEE 802.11 protocol.

14. The wireless access point of claim 13, wherein the second wireless communication protocol is a Long Term Evolution (LTE) protocol.

15. The wireless access point of claim 9, wherein the instructions are executable to receive in the first wireless communication system a message from the second wireless communication system, wherein the instructions executable to determine the first period comprise instructions executable by the processor to determine the first period in response to receiving the message.

16. The wireless access point of claim 15, wherein the message identifies an at least one from the group consisting of:
an operating frequency band in the second wireless communication system;
a pattern of upload sub-frames and download sub-frames included in frames implemented in the second wireless communication system; and
a format of special sub-frames included in frames implemented in the second wireless communication system.

17. A wireless access point comprising:
means for determining in a first wireless communication system a first period during which at least one device in a second wireless communication system will be communicating in the second wireless communication system; and
means for delaying a transmission in the first wireless communication system scheduled to be transmitted during the first period until after the first period.

18. The wireless access point of claim 17, wherein the delayed transmission comprises a beacon.

19. The wireless access point of claim 17, wherein communicating comprises an at least one from the group consisting of:
transmitting data during uplink or downlink depending on a mode of the second wireless communication system; and
receiving data during uplink or downlink depending on the mode of the second wireless communication system.

20. The wireless access point of claim 17, wherein the first wireless communication system implements a first wireless communication protocol and the second wireless communication system implements a second wireless communication protocol, the first wireless communication protocol different than the second wireless communication protocol.

21. The wireless access point of claim 20, wherein the first wireless communication protocol is an IEEE 802.11 protocol.

22. The wireless access point of claim 21, wherein the second wireless communication protocol is a Long Term Evolution (LTE) protocol.

23. The wireless access point of claim 17, further comprising means for receiving in the first wireless communication system a message from the second wireless communication system, wherein the means for determining the first period comprises means for determining the first period in response to receiving the message.

24. The wireless access point of claim 23, wherein the message identifies an at least one from the group consisting of:
an operating frequency band in the second wireless communication system;
a pattern of upload sub-frames and download sub-frames included in frames implemented in the second wireless communication system; and
a format of special sub-frames included in frames implemented in the second wireless communication system.

25. A computer program product for minimizing interference, the computer program product comprising a non-transitory computer-readable medium storing instructions executable by a processor to:
determine in a first wireless communication system a first period during which at least one device in a second wireless communication system will be communicating in the second wireless communication system; and
delay a transmission in the first wireless communication system scheduled to be transmitted during the first period until after the first period.

26. The computer program product of claim 25, wherein the delayed transmission comprises a beacon.

27. The computer program product of claim 25, wherein communicating comprises an at least one from the group consisting of:
transmitting data during uplink or downlink depending on a mode of the second wireless communication system; and
receiving data during uplink or downlink depending on the mode of the second wireless communication system.

28. The computer program product of claim 25, wherein the first wireless communication system implements a first wireless communication protocol and the second wireless communication system implements a second wireless communication protocol, the first wireless communication protocol different than the second wireless communication protocol.

29. The computer program product of claim 28, wherein the first wireless communication protocol is an IEEE 802.11 protocol.

30. The computer program product of claim 29, wherein the second wireless communication protocol is a Long Term Evolution (LTE) protocol.
